(19) United States
(12) Patent Application Publication
(10) Pub. No.: US 2011/0096559 A1
(43) Pub. Date: Apr. 28, 2011

(54) Stern LED Lighting Device

(76) Inventor: I-Sin PENG, Taichung City (TW)

(21) Appl. No.: 12/164,915

(22) Filed: Jun. 30, 2008

(51) Int. Cl. B60Q 1/00

(52) U.S. Cl. 362/477

(57) ABSTRACT

A stern LED lighting device includes a base comprising at least a pair of lower threaded holes at opposite ends thereof, a trough at a center portion thereof, and at least one wire hole at a bottom of the base, a number of insertion sockets and a pair of posts being provided on the trough; a LED module comprising a number of light emitting diodes at a center portion thereof, a pair of through holes at opposite ends thereof; a reflector frame having a flat part, a slope part, a number of insertion posts protruding from a bottom of the reflector frame, and a first opening at a center portion thereof; a protecting board being a ladder-shaped and transparent board, and comprising a lower part and an upper part; and a cover having at least a pair of upper threaded holes at opposite ends thereof, a second opening at a center portion thereof.

### BACKGROUND OF THE INVENTION

1. Field of the Invention

The present invention relates to a stern LED lighting device, and more particularly to a lighting device having a LED module with a plurality of light emitting diodes and an upper part of a protecting board having an arcuate or polygonal surface to provide an appropriate curvature corresponding to the relative position of the light emitting diodes. The light from the light emitting diodes is refracted and radiated out through the upper part of the protecting board to provide more brightness and to a larger area.

2. Description of the Prior Art

A conventional stern light uses a tungsten light bulb as the light source, which has a high temperature. It needs a container to protect people from burning accident. When the light bulb malfunctions, it is necessary to replace a new one for sequent usage. The light bulb is breakable, radiates heat, consumes power, and has a shorter service time. When the light bulb is damaged, the user has to wait until the temperature of the light bulb drops, and then replace a new one with a tool. This is not convenient and wastes time. Usually, the conventional stern light is installed with one light bulb only. When the light bulb malfunctions, the lamplight is gone out. This causes danger to drive a boat in the night.

Accordingly, the inventor of the present invention has devoted himself based on his many years of practical experiences to the development of a stern LED lighting device to improve safety for driving a boat.

### SUMMARY OF THE INVENTION

According to the present invention, there is provided a stern LED lighting device, comprising a base comprising at least a pair of lower threaded holes at opposite ends thereof, a trough at a center portion thereof, and at least one wire hole at a bottom of the base, a number of insertion sockets and a pair of posts being provided on the trough; a light emitting diode (LED) module comprising a number of light emitting diodes at a center portion thereof, a pair of through holes at opposite ends thereof; a reflector frame having a flat part, a slope part, a number of insertion posts protruding from a bottom of the reflector frame, and a first opening at a center portion thereof; a protecting board being a ladder-shaped and transparent board, and comprising a lower part and an upper part; and a cover having at least a pair of upper threaded holes at opposite ends thereof, a second opening at a center portion thereof.

It is the primary object of the present invention to provide a stern LED lighting device, which is cost-effective, increases reliability, consumes less electrical energy, and has a longer service time.

It is another object of the present invention to provide a stern LED lighting device, which is easy to replace.

It is a further object of the present invention to provide a stern LED lighting device, which saves power and provides more brightness.

It is a further object of the present invention to provide a stern LED lighting device, which provides more options for different colors of light.

### BRIEF DESCRIPTION OF THE DRAWINGS

FIG. 1 is an exploded view of a stern LED lighting device according to a preferred embodiment of the present invention;

FIG. 1-A is a perspective view showing the bottom of a base of the stern LED lighting device according to the preferred embodiment of the present invention;

FIG. 2 is a perspective view of the stern LED lighting device according to the preferred embodiment of the present invention;

FIG. 2-A is a perspective view showing the base, a LED module and a reflector frame of the stern LED lighting device according to the preferred embodiment of the present invention; and

FIG. 3 is a cross-sectional view showing the stern LED lighting device according to the preferred embodiment of the present invention mounted on the stern of a boat.

### DETAILED DESCRIPTION OF THE INVENTION

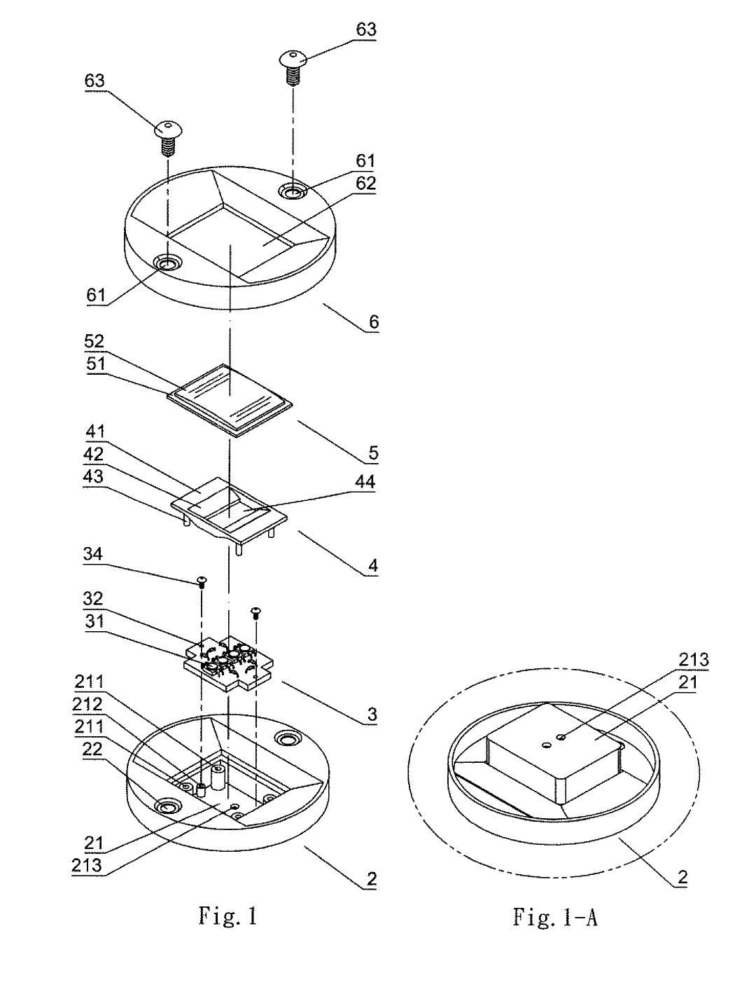

As shown in FIGS. 1, 1-A, and 2, a stern LED lighting device according to a preferred embodiment of the present invention comprises a base 2, a light emitting diode (LED) module 3, a reflector frame 4, a protecting board 5, and a cover 6.

The base 2 comprises at least a pair of lower threaded holes 22 at opposite ends thereof, a trough 21 at a center portion thereof, and at least one wire hole 213 at the bottom of the base 2. A number of insertion sockets 211 and a pair of posts 22 are provided on the trough 21 of the base 2.

The LED module 3 comprises a number of light emitting diodes 31 at a center portion thereof, a pair of through holes 32 at opposite ends thereof, and power wires 33 extending through the bottom of the LED module 3. The light emitting diodes 31 may be in different colors for changeable purpose, The through holes 32 correspond in position to the posts 212. The LED module 3 is located in the through 21 of the base 2, with screws 34 inserting through the through holes 32 and secured to the posts 212. The LED module 3 is shaped to keep away from the insertion sockets 211.

The reflector frame 4 has a flat part 41, a slope part 42, a number of insertion posts 43 protruding from the bottom of the reflector frame 4, and a first opening 44 at a center portion thereof.

The protecting board 5 is a ladder-shaped and transparent board, and comprises a lower part 51 and an upper part 52. The lower part 51 engaging with the flat part 41 of the reflector frame 4 is adhered or embedded to the trough 21 of the base 2 so as to protect the reflector frame 4 and the LED module 3. The upper part 52 has a flat, arcuate or polygonal surface for various changes. The light from the LED module 3 permeates through the protecting board 5 for lighting.

The cover 6 has at least a pair of upper threaded holes 61 at opposite ends thereof, a second opening 62 at a center portion thereof, and screws 63. The cover 6 fits onto the base 2 with the upper threaded holes 61 corresponding in position to the lower threaded holes 22. The edge of the second opening 62 engages with the edge of the lower part 51 of the protecting board 5 to secure the protecting board 5 in place. The cover 6 is made of metal or plastic materials.

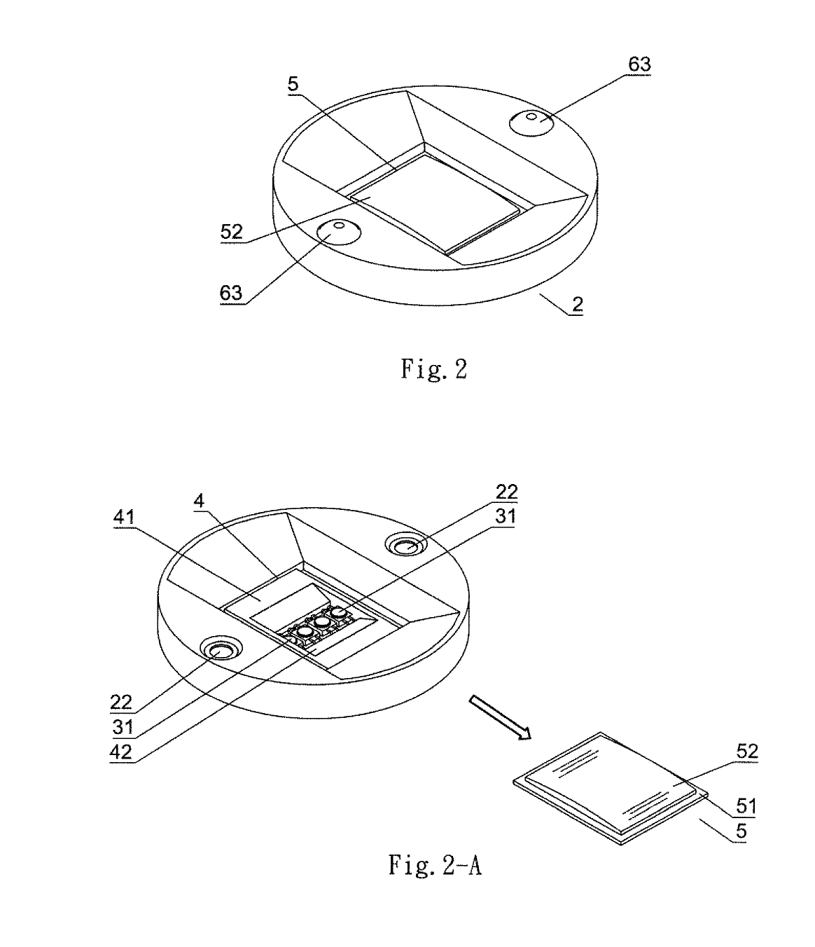

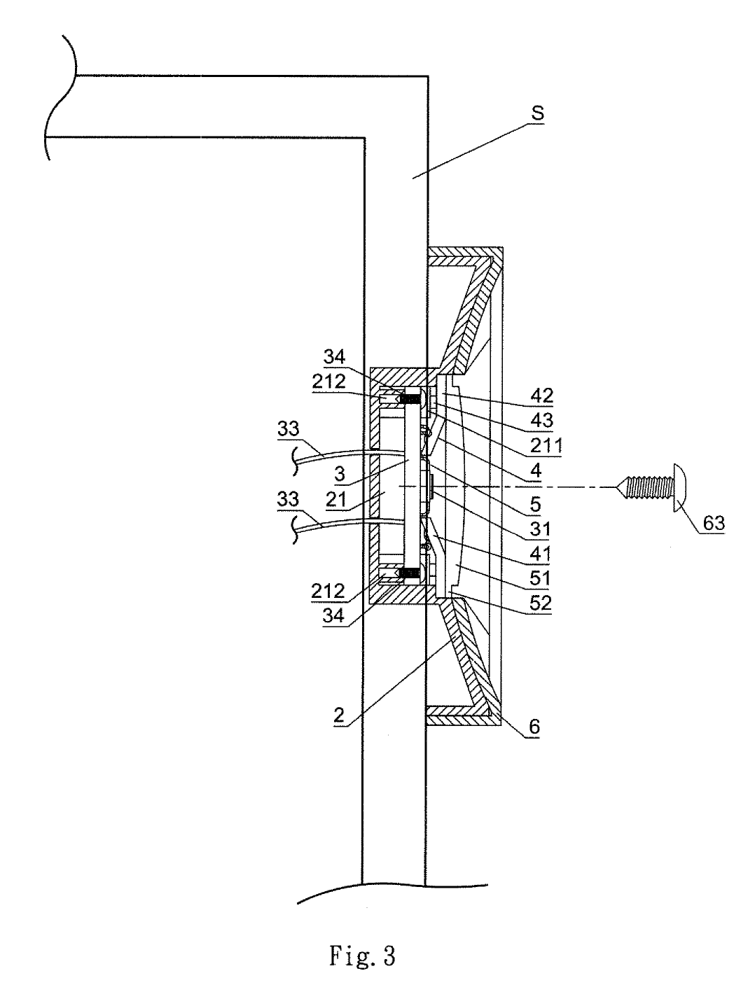

To assemble the present invention, as shown in FIGS. 1, 2-A, and 3, the LED module 3 is placed onto the posts 22, and the screws 34 are inserted through the through holes 32 and secured to the posts 22. The power wires 33 are inserted through the wire hole 213 of the base 2 and connected to a power switch of a boat S. The first opening 44 of the reflector frame 4 corresponds in position to the light emitting diodes 31. The insertion posts 43 are inserted into the insertion sockets 211 of the base 2. The protecting board 6 engages with the flat part 41 of the reflector flame 4 and is embedded to a top edge of the trough 21. The cover 6 fits onto the base 2. The screws 63 are screwed into the upper threaded holes 61 and the lower threaded holes 22 to secure the LED lighting device to the stern of the boat S.

As shown in FIGS. 2-A and 3, each of the light emitting diodes 31 functions as an illuminating unit. The upper part 52 of the protecting board 5 has the arcuate or polygonal surface in conjunction with the position of the light emitting diodes 31 to provide an appropriate curvature. The light from the light emitting diodes 31 of the LED module 3 is refracted and radiated out through the upper part 52 of protecting board 5. To use the LED as a light source improves safety because it saves power and provides more brightness and reliability than a conventional light bulb. In case one of the light emitting diodes 31 malfunctions, other light emitting diodes 31 still function normally.

One of the characteristics of the light emitting diodes 31 is monochromatic light on different frequency and wavelength of spectrum to radiate different color of light. Due to the plurality of light emitting diodes 31, this design provides different options for color of light. The LED module 3 is replaceable for a desired color, which is cost-effective.

To use the assembly of the light emitting diodes 31 and the protecting board 5, different curvature of the upper part 52 to change beam route, inside embedded position, and outside securing way is convenient and improves safety.

Although particular embodiment of the present invention have been described in detail for purposes of illustration, various modifications and enhancements may be made without departing from the spirit and scope of the present invention. Accordingly, the present invention is not to he limited except as by the appended claims.

What is claimed is:

1. A stern light emitting diode (LED) lighting device, comprising:
a base comprising at least a pair of lower threaded holes at opposite ends thereof, a trough at a center portion thereof, and at least one wire hole at a bottom of the base, a number of insertion sockets and a pair of posts being provided on the trough;
a light emitting diode (LED) module comprising a number of light emitting diodes at a center portion thereof, a pair of through holes at opposite ends thereof;
a reflector frame having a flat part, a slope part, a number of insertion posts protruding from a bottom of the reflector frame, and a first opening at a center portion thereof;
a protecting board being a ladder-shaped and transparent board, and comprising a lower part and an upper part; and
a cover having at least a pair of upper threaded holes at opposite ends thereof, a second opening at a center portion thereof.

2. The stern light emitting diode (LED) lighting device as claimed in claim 1, wherein the cover is made of metal.

3. The stern light emitting diode (LED) lighting device as claimed in claim 1, wherein the cover is made of plastic material.

4. The stern light emitting diode (LED) lighting device as claimed in claim 1, wherein the upper part of the protecting board has a flat surface.

5. The stern light emitting diode (LED) lighting device as claimed in claim 1, wherein the upper part of the protecting board has an arcuate surface.

6. The stern light emitting diode (LED) lighting device as claimed in claim 1, wherein the upper part of the protecting board has a polygonal surface.
